(19) United States
(12) Patent Application Publication
(10) Pub. No.: US 2006/0087774 A1
(43) Pub. Date: Apr. 27, 2006

(54) Protection system against an electric motor overload

(75) Inventor: Thomas Bielesch, Muhlacker (DE)

Correspondence Address: FOLEY AND LARDNER LLP;SUITE 500, 3000 K STREET NW, WASHINGTON, DC, 20007, US

(73) Assignee: BEHR GmbH & CO. KG

(21) Appl. No.: 10/548,659

(22) PCT Filed: Mar. 3, 2004
(86) PCT No.: PCT/EP04/02131

§ 371 Date: Nov. 14, 2005

(30) Foreign Application Priority Data
Mar. 10, 2003 (DE) 103 10 718.5

(51) Int. Cl. H02H 7/08

(52) U.S. Cl. 361/23

(57) ABSTRACT

In order to ensure a significantly efficient protection for several electric motors, even serially arranged, the invention provides for a protection system (1) against an electric motor (2) overload, in particular for an electrically controlled vehicle ventilator. The electric motor (2) is provided with a three pole connection whose two elements are connected to a switching element (4) which is in parallel connected to the electric motor (2), thereby forming a thermal contact therewith in such a way that said switching element (4) is trigged when a temperature is increased, in particular for disconnecting the relevant electric motor (2) by a corresponding connection.

The invention relates to an arrangement for overload protection of an electric motor, in particular of an electrically driven fan blower for a vehicle.

In vehicles, in particular internal combustion engines, electrically operated fan blowers are used for cooling the internal combustion engines. This makes it possible to control and regulate, in a targeted manner, the heat balance in the internal combustion engine. In this case, the fan blower or the fan is usually operated at one or more rotation speed levels. The fan is usually connected directly, without any additional series resistors, to a battery supply for supplying the full battery voltage at the maximum rotation speed level. An on-board power supply system fuse is therefore generally provided in particular for the purpose of protecting the wiring from fire owing to overload. This fuse is also used for protecting the fan against possible fire owing to overload if, for example, the fan becomes blocked at the maximum rotation speed level.

In the field of air conditioning systems for protecting against excessive temperatures, reversible thermal circuit breakers are generally connected in the circuit of the relevant thermal components, as a result of which, in the event of a fault, i.e. in the event of an excessive temperature, the current flow in this circuit is interrupted. For this purpose, the thermal circuit breaker is in the form of a normally closed contact. Since the thermal circuit breaker is designed in a known manner to be reversible, it is switched on again once the temperature has fallen below the critical temperature. Such circuit breakers can be used only to a limited extent in the motor cooling sector owing to the limited functional range and temperature range and the high current loading. Furthermore, owing to their design, conventional on-board power supply system fuses have high tolerances which, in particular as a consequence of aging, result in it being possible for the tripping value originally set to differ over the life or over time. In addition, this characteristic is intensified by the thermal characteristic of the fan since, when the fan is blocked, its internal resistance increases owing to heating. A complicating factor is, in addition, the increase in resistance in the feed lines owing to them being heated. In addition, this problem also occurs in the case of a fuse integrated in the fan or blower. In order to alleviate this problem, the on-board power supply system fuse may be designed to have a lower tripping value. However, this may lead to earlier response of the on-board power supply system fuse in unwanted cases as well. Furthermore, premature response of the on-board power supply system fuse and thus disconnection of the fan may lead to overheating of the cooling system and possibly to damage to the internal combustion engine if the fault is not recognized in good time.

In addition, it is also known for a plurality of, for example two, fan blowers to be used which are connected both in series for a minimum rotation speed and in a parallel circuit for a maximum rotation speed by means of a changeover element, for example a changeover relay. In this case, if a fault occurs in one of the fans, for example one fan becomes blocked, during operation of the fans in a parallel circuit, owing to an overcurrent resulting therefrom a fuse element, for example an on-board power supply system fuse, may be tripped, as a result of which the circuit is interrupted. In contrast, in the event of a fault of fans arranged in a series circuit, there is an increase in the internal resistance of the fan and of the feed lines, as a result of which the current remains below the tripping current of the fuse element. Here too, as the age of the on-board power supply system fuses increases, the desired response values may differ beyond predetermined tolerances.

Irrespective of the design of the fan system, protection by means of simple components such as the use of fuses can thus not always be implemented in all specification ranges and often has to be achieved using considerable additional measures.

The invention is therefore based on the object of specifying an arrangement for overload protection of an electric motor, which also provides sufficiently effective protection without a protection element being tripped prematurely in an unwanted manner.

The object is achieved according to the invention by an arrangement for overload protection of an electric motor, in particular of an electrically driven fan blower for a vehicle, the electric motor being provided with a multipole connection, of which two connection elements are associated with a switching element which is connected in parallel with the electric motor such that it is in thermal contact with said electric motor and such that, in the event of excessive temperatures, it causes the relevant switching element to trip.

Advantageous developments of the invention are the subject matter of the subclaims.

In this case, the invention is based on the consideration that, in the event of excessive temperatures on one of the electric motors, for example owing to sluggishness or owing to a fan, which is driven by the electric motor, being blocked on account of a foreign body having entered the electric motor, a considerable thermal load may result, in particular excessive heating, which consequently leads to a rise in the internal resistance of the electric motor. This in turn leads to a fuse arranged in the circuit of the electric motor not responding owing to the current flow being limited by the increased internal resistance. According to the invention, the electric motor is therefore provided with a multipole connection, of which two connection elements are associated with a switching element which is connected in parallel with the electric motor such that it is in thermal contact with said electric motor. Owing to such an integration of a switching element directly at the electric motor, in particular at a point at which the highest temperatures may occur during operation or in the event of blocking, and association of connection elements, particularly simple and sufficiently effective monitoring and plausibility checking of the tripping of the switching element is also made possible (in addition to particularly simple and cost-effective contact-making and, as a result thereof, particularly accurate and rapid tripping in the event of overheating and thus in the event of a fault), i.e. the fact that the critical temperatures are detected directly at the element bringing about the temperature increase itself and connection elements of the multipole connection are associated with the switching element means that protection which is as rapid and reliable as possible is provided against fire and overheating with, at the same time, effective monitoring and plausibility checking of the requirements for the switching element that are requisite for this protection.

The multipole connection is expediently in the form of a plug or cable connection. For example, the multipole connection is in the form of a three-pole plug connection or, in analogous fashion, in the form of a three-core cable connection in an alternative embodiment. An associated motor connection can thus take place in the standard way using a plug or using a corresponding cable connection.

Depending on the type and design of the arrangement, the switching element may be in the form of a normally closed contact, a normally open contact or a changeover switch. The switching element is preferably in the form of a normally closed contact and is connected between the positive or negative connection element and a further connection element of the multipole connection. This makes possible a particularly simple and cost-effective circuit, in which one of the switch contacts of the switching element is connected directly to the negative or minus connection element of the electric motor. As an alternative to this and, in particular, in order to link in further applications, one of the switch contacts of the switching element is connected directly to the positive or plus connection element of the electric motor. The second switch contact is in both cases (connection to minus pole or plus pole) connected to a further, for example a central, connection element of a three-pole connection of the electric motor. This contact or this central connection element may expediently be designed for low currents compared with the connection elements also used as motor connections.

As an alternative to the switching element in the form of a normally closed contact, said switching element may also be in the form of a changeover switch in a further preferred embodiment. In this case, the switching element is preferably connected on the voltage side between the positive and the negative connection element of the multipole connection and on the circuit side to a further connection element, for example a central connection element of the multipole connection.

Depending on the specifications, the multipole connection may be designed variously. For example, the multipole connection may preferably be in the form of a three-pole (or three-core) connection. Alternatively, the connection may be in the form of a two-pole connection (or two-core connection) having an additional contact or an additional cable, the additional contact serving the purpose of identifying overload of the electric motor.

In order to be able to reliably recognize a temperature-dependent fault, the switching element is expediently in the form of a temperature-dependent component. In one possible embodiment, the switching element may be in the form of a thermal circuit breaker, in particular in the form of a bimetallic strip, in the form of a semiconductor component, for example a TEMPFET, or in the form of a temperature-dependent resistor. Such thermal, in particular reversible, releases bend on heating and thus trip in the event of an excessive temperature. Other alternative electronic or mechanical components having correspondingly temperature-dependent characteristics, such as PTC thermistors or else semiconductor switches, may also be used as the switching elements.

For particularly reliable and simple detection of excessive temperatures in the electric motor, the switching element is integrated in the electric motor. At least one interference suppression element, for example a capacitor, is expediently connected in parallel with the switching element.

In one preferred embodiment, in this case the switching element is arranged on a brushplate of the electric motor. As a result, sufficiently effective thermal contact is made and thus heat transfer which is as effective as possible is provided for the purpose of identifying the excessive temperatures and thus the overload in the electric motor. Furthermore, such an arrangement of the switching element on the brushplate takes up little physical space and can thus be inserted into existing free spaces in a particularly simple and problem-free manner and can consequently be retrofitted easily.

The switching element is preferably designed such that tripping takes place at a temperature of greater than 50° C., in particular in a range from 50° C. to 220° C., preferably in a range from 150° C. to 210° C. In other words: for a simple refinement of the switching element it is sufficient for its tolerance ranges for tripping to lie in the upper, critical temperature range of the electric motor.

In addition, a fuse element is expediently provided for the purpose of disconnecting a circuit supplying the electric motor in the event of a critical limit value of, for example, 60 A being exceeded. In other words: in addition to the temperature-dependent tripping of the switching element and thus to a first stage of the fault detection owing to overload of the faulty electric motor, in a second stage a fuse element may be provided for current-dependent tripping purposes. As a result, when a critical current value of, for example, greater than 60 A is exceeded, the circuit for supplying current to the electric motor is interrupted. In order to prevent electromagnetic interference when switching the switching element on and/or off, an interference suppression capacitor may expediently be connected in parallel with the switching element. Depending on the requirements, other interference suppression elements may also be used.

In order to monitor the functions of the electric motor, at least one connection element of a motor feed line is connected to a feedback line. Depending on the type and design, the connection element of a motor feed line may be connected to a feedback line via a decoupling element, for example a diode. A changeover element, for example a relay, for changing over from one rotation speed level to another may also be provided for the purpose of controlling the electric motor as a function of the rotation speed. In this case, the changeover element is preferably also connected to a feedback line.

Depending on the application case, a plurality of electric motors may also be connected in series or in parallel with one another. In one preferred embodiment, in this case a switching element is expediently associated with each electric motor, it being possible for the switching elements to trip independently of one another. If, in the event of a fault, only one of the electric motors automatically switches off by means of the associated switching element and its downstream, separate monitoring device, the other electric motor may continue to be operated as normal, preferably at an increased rotation speed for the purpose of increasing the cooling and thus air power.

The advantages achieved by the invention consist in particular in the fact that, in the event of a short circuit of an electric motor brought about, for example, by excessive temperatures, detection and monitoring of the critical temperatures directly at the heat source is possible owing to the integration of a switching element in the electric motor itself, said switching element being in thermal contact with the electric motor. Owing to a switching element which is associated with the electric motor, for example a fan or blower, and its connection to a multipole, for example a three-pole, connection of the electric motor, separate monitoring and thus reliable and accurate disconnection of the faulty motor are possible. Once the fault has been eliminated, the normal operation of the electric motor can be activated again by the switching element being switched on.

Exemplary embodiments of the invention will be explained in more detail with reference to a drawing, in which:

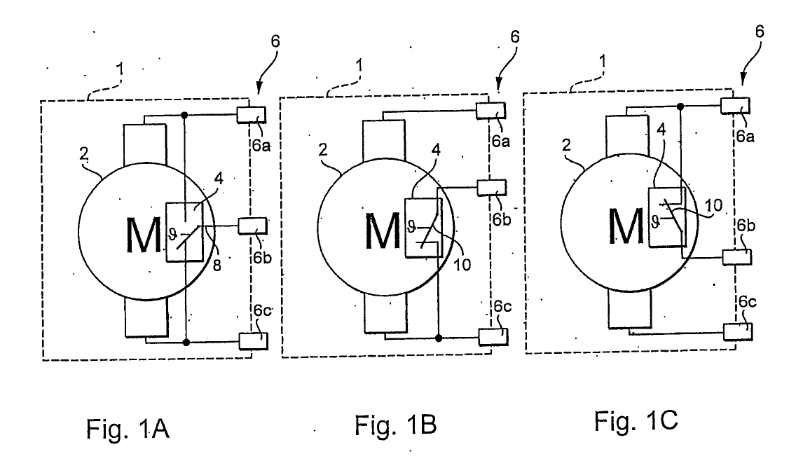

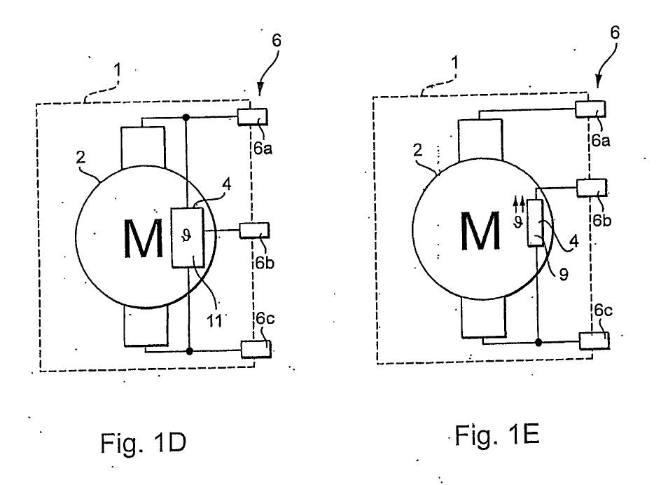

FIGS. 1A to 1E show schematic illustrations of various arrangements for overload protection of an electric motor having an associated switching element (in each case having a different design and connected in a different way) in the normal state,

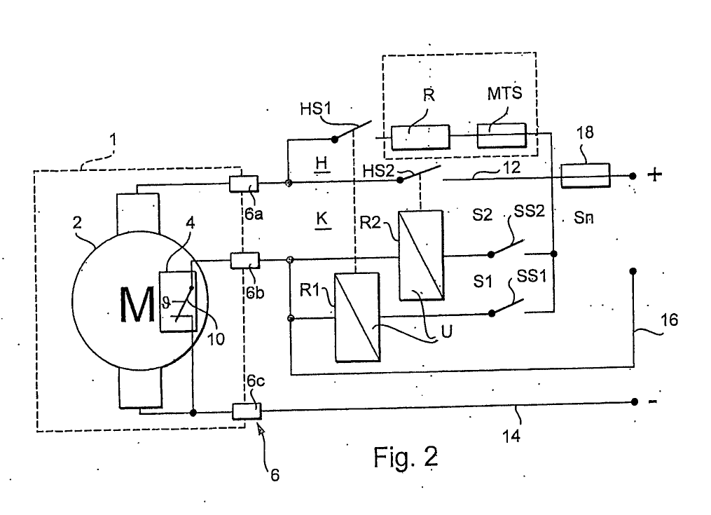

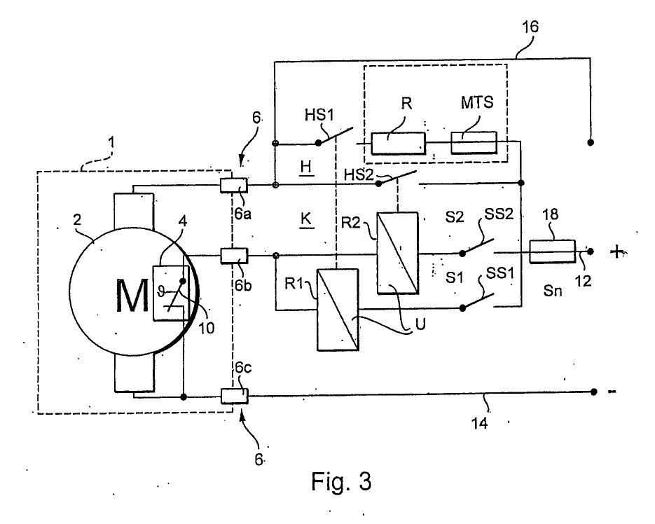

FIGS. 2, 3 show schematic illustrations of further embodiments of an arrangement for overload protection of an electric motor having two-stage rotation speed control,

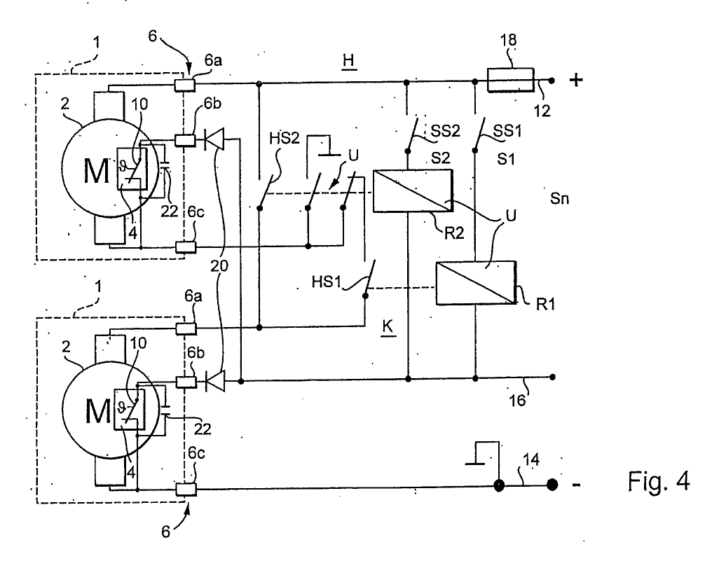

FIG. 4 shows a schematic illustration of an embodiment of an arrangement for overload protection for two electric motors connected to one another in a series/parallel circuit, and

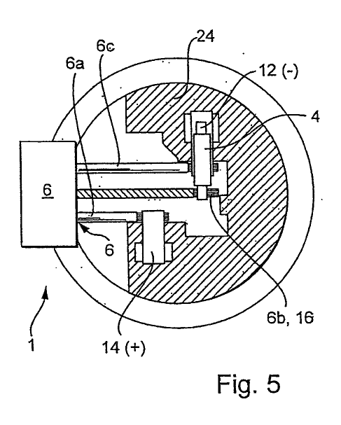

FIG. 5 shows a schematic illustration of an example of an installation site for the switching element in the electric motor.

Mutually corresponding parts are provided with the same references in all of the figures.

FIG. 1A shows a circuit for an arrangement 1 for overload protection (referred to for short below as protective arrangement 1) of an electric motor 2. The electric motor 2 is, for example, a drive for a fan (not illustrated in any more detail) or a blower of a vehicle (not illustrated in any more detail) for the purpose of ventilating an internal combustion engine (not illustrated in any more detail) of the vehicle. In order to protect the fan and its electric motor 2 against an overload, such as may occur, for example, when the blower or fan becomes blocked, the protective arrangement 1 comprises a switching element 4 which is connected in parallel with the electric motor 2.

A multipole, for example a three-pole, connection 6 having three connection elements 6a to 6c is provided both for supplying voltage to the electric motor 2 and for monitoring the state of the switching element 4. The two outer connection elements 6a and 6c are used, inter alia, for supplying voltage to the electric motor 2, one of the outer connection elements 6a representing the plus connection, and the other outer element representing the minus connection. Depending on the type and design of the multipole connection 6, said multipole connection may be in the form of a plug or cable connection. In the case of a three-pole connection, said connection may also be in the form of a two-pole connection having an additional contact or in the form of a standard three-pole connection. A conventional motor plug connection having two contacts or connections may also be supplemented by the monitoring function of the switching element 4, described below, by adding the additional contact.

The switching element 4 is integrated directly in the drive or electric motor 2, i.e. for a reliable, thermal contact-making arrangement of the switching element 4, said switching element is fitted directly to the electric motor 2, for example at a suitable point, in particular directly in the vicinity of a location at which the heat is produced in the event of a fault. In one preferred embodiment, the switching element 4 is arranged, for example, on that side of the brushplate (not illustrated in any more detail) of the electric motor 2 which is fitted with components. As an alternative, the switching element 4 may also be fitted at another point which is reliably suitable for thermal tripping.

The switching element 4 is preferably in the form of a temperature-dependent component, for example in the form of a reversible thermal circuit breaker, for example in the form of a bimetallic strip. In one possible embodiment, as shown in FIG. 1A, the switching element 4 is in the form of a changeover switch 8. In this case, the changeover switch 8 is connected on the voltage side to the two outer connection elements 6a and 6c of the multipole connection 6. On the circuit side, the changeover switch 8 is connected to the central connection element 6b. Owing to the fact that the central connection element 6b is only connected on the circuit side, said connection element 6b may be designed for low currents.

FIGS. 1B and 1C show alternative embodiments for the switching element 4 and the way in which it is connected, in terms of circuitry, to the connection 6 of the electric motor 2. In both FIGS. 1B and 1C, the switching element 4 is in each case in the form of a normally closed contact 10. As an alternative, the switching element 4 may also be in the form of a normally open contact in a manner which is not illustrated in any more detail. Only the wiring of the switching element 4 to the connection 6 of the electric motor 2 is different. In FIG. 1B, the switching element 4 is connected between the central connection element 6b and the outer, negative connection element 6c acting, for example, as the negative connection. In contrast, in FIG. 1C the switching element 4 is connected between the central connection element 6b and the outer, positive connection element 6a acting as the plus connection.

FIGS. 1D and 1E show further exemplary embodiments of the switching element 4, for example in the form of a temperature-dependent semiconductor element 11, for example of an electronic component such as a TEMPFET, which may be designed with or without additional circuitry, or of a temperature-dependent resistor 9, such as a PTC thermistor.

In the event of a fault in the electric motor 2, for example owing to it being blocked, excessive temperatures may result. For example, the critical temperature Θ is approximately 180° C., depending on the application case. This excessive temperature in the electric motor 2 results in the internal resistance Ri of the electric motor 2 falling below a tripping current required for tripping a conventional fuse, for example a limit value of 60 A, which in turn results in considerable thermal loading. In order to prevent such thermal loads, the switching element 4 is designed, for example, such that, owing to its arrangement in thermal contact with the electric motor 2, tripping takes place at a temperature Θ of greater than 50° C., in particular in a range from 50° C. to 220° C., preferably in a range from 150° C. to 210° C., as a result of which the voltage supply to the electric motor 2 is interrupted when the switching element 4 is tripped. Various embodiments in terms of circuitry for the tripping and arrangement of the switching element 4 will be described in more detail below with reference to the further figures.

FIG. 2 shows an exemplary circuit for an arrangement 1 for protecting the electric motor 2 which is operated, for example, for a multi-stage fan system having a plurality of rotation speed stages Sn, for example for two rotation speed stages S1 and S2. The two outer connection elements 6a and 6c of the multipole, in particular three-pole, connection 6 serve the purpose of supplying voltage to the electric motor 2 and are connected to the plus pole “+” of a battery (not illustrated in any more detail) via a plus line 12 and to the minus pole “−” of the battery via a minus line 14. The switching element 4 is in the form of a normally closed contact 10 and is connected between the outer connection element 6c and the central connection element 6b, also referred to as the connection of the electric motor 2. The switching element 4 is connected in series with the parallel-connected rotation speed stages S1 and S2 by the plus line 12 via the connection or the central connection element 6b. The rotation speed stages S1 and S2 each comprise, as a changeover element U, a relay R1 or R2 and an associated switch SS1 or SS2. The respective relay R1 or R2 is driven via the associated switch SS1 or SS2, as a result of which respectively associated heavy-duty switches HS1 and HS2 are connected for the respective rotation speed stage S1 and S2. In addition, a feedback line 16 (also referred to as a monitoring line) can be arranged in parallel with the rotation speed stages S1 and S2 in series with the switching element 4 directly downstream of the output of the central connection element 6b. The feedback line 16 is, for example, connected to an input of a motor and/or battery control device in a manner which is not illustrated in any more detail.

During operation of the arrangement 1, one of the switches SS1 or SS2 for the rotation speed stage S1 or S2 of the electric motor 2 is actuated, so that the electric motor 2 is started. In the process, the control current for the relevant relay R1 or R2 flows in a circuit K from the plus line 12, via an on-board power supply system fuse 18 which is possibly connected in the plus line 12, via the relevant relay R1 or R2 and via the switching element 4, to the minus line 14. The monitoring or feedback line 16 for the switching element 4 is thus connected to the minus potential.

If there is a rise in the temperature Θ of the electric motor 2 and, for example owing to the fan being blocked, a rise in the temperature Θ in an impermissible temperature range, the switching element 4 which is in thermal contact with the electric motor 2, is tripped, i.e. the circuit K is interrupted hereby so that both relays R1 and R2 release and interrupt the main circuit H. When the circuit K is interrupted by the switching element 4, the feedback line 16 is connected to the plus potential. The switching element 4 is preferably provided with switching hysteresis for, tolerance ranges. In addition, the resistor R of the first fan stage can also be protected by means of a microtemperature fuse MTS connected in series with the resistor R.

Depending on the type and connection of the feedback line 16, a connected motor controller can now, for example, drive the electric motor 2 using the applied plus potential, at the same time the fault message for increased temperature Θ of the electric motor 2 being output and possibly displayed. Depending on the functionality of the relevant motor controller, the system can be reset automatically again to the original state once, if appropriate, the fault has been eliminated and/or the electric motor 2 has been appropriately cooled, owing to corresponding driving.

FIG. 3 shows an alternative embodiment for the arrangement 1, the feedback line 16 being connected to the outer connection element 6a. As an alternative or in addition, information can thereby be obtained regarding the state of the drive or electric motor 2 indirectly as well as information on the state of the switching element 4, in contrast to the connection to the central connection element 6b, i.e. it is possible to check, by means of such a circuit arrangement, whether the electric motor 2 is supplied with voltage or whether a fault owing to excessive temperature may, have been triggered in the electric motor 2. In addition, tripping of a fuse element 18, which acts as the on-board power supply system fuse, can be monitored indirectly by means of the feedback line 16 owing to it being connected directly downstream of the output of the outer connection element 6a and in parallel with, said fuse element 18. The electric motor 2 is provided with two rotation speed stages S1 and S2 and the associated driving by means of the respective relays R1 and R2, switches SS1 and SS2 and heavy-duty switches HS1 and HS2, as illustrated in FIG. 2.

FIG. 4 shows a further application case. In this case, for example two identical or similar drive or electric motors 2 are provided for one ventilation system. The electric motors 2 are in this case connected to one another in series or in parallel, i.e., in order to operate such a two-stage fan system for the internal combustion engine at different rotation speed stages Sn, the two electric motors 2 can be connected firstly in series for a minimum rotation speed at the rotation speed stage S1 and secondly in parallel for a maximum rotation speed at the rotation speed stage S2 by means of a changeover element U. In order to protect the main circuit H, the on-board power supply system fuse 18 is furthermore connected in series with the electric motors 2.

If, for example, one of the electric motors 2 now becomes blocked during operation of the two electric motors 2 in the series circuit, this electric motor acts as a series resistor for the other electric motor 2 so that, in this case, no critical temperature range is reached. In this case, the still intact electric motor 2 continues to be operated automatically at a correspondingly higher power.

If the situation now arises in the series circuit, however, that both electric motors 2 become blocked, the fuse element 18 in the most unfavorable case does not respond, owing to the high internal resistances of the electric motors 2, and overheating may occur. In order to prevent this, each electric motor 2 is provided with an associated switching element 4. If both electric motors 2 now become blocked, in the case of the series circuit of the two electric motors 2, that switching element 4 whose electric motor 2 is connected to the minus line 14 responds at the rotation speed stage S1 owing to increasing temperatures Θ. As a result, the circuit K is interrupted by the two relays R1 and R2 at rotation speed stages S1 and S2.

In another case, in which both electric motors 2 are operated at the maximum rotation speed stage S2 (=parallel operation of the two electric motors 2 using the battery voltage), the system is protected via the fuse element 18.

In order to decouple the two switching elements 4, diodes 20 are provided. In a preferred application type, these diodes 20 may also be integrated in the electric motors 2 and connected with any desired switching element 4, as described in FIGS. 1A to 1E. Furthermore, in a further embodiment, the diodes 20 required are integrated directly in the relays R1 or R2, or else in other driving devices. Depending on the type and design, an interference suppression element 22, for example an interference suppression capacitor, may also be connected in parallel with the respective switching element 4. As already described in FIG. 2 and

FIG. 3, the functioning of the system may also in this case be monitored and indirectly interrogated using an additional feedback line 16.

FIG. 5 shows one example of a possible installation site for the switching element 4 in the electric motor 2. In one preferred embodiment, the switching element 4 is arranged, for example, on a carrier plate 24 (also referred to as brushplate) of the electric motor 2. For a reliable, thermal contact-making arrangement of the switching element 4, said switching element is thus fitted directly to the electric motor 2, for example at a suitable point, in particular directly in the vicinity of a location at which the heat is produced in the event of a fault.

### LIST OF REFERENCES

1 Arrangement for overload protection of an electric motor
2 Electric motor
4 Switching element
6 Multipole connection
6a, 6b, 6c Connection elements
8 Changeover switch
9 Temperature-dependent resistor
10 Normally closed contact
11 Temperature-dependent semiconductor component
12 Plus line
14 Minus line
16 Feedback line
18 On-board power supply system fuse
20 Diodes
22 Interference suppression elements
24 Carrier plate
H Main circuit
K Circuit
MTS Microtemperature fuse
R Resistor
R1, R2 Relays
U Changeover element
S1, S2, Sn Rotation speed stages
SS1, SS2 Switches
HS1, HS2 Heavy-duty switches
Θ Temperature

1. An arrangement (1) for overload protection of an electric motor (2), in particular of an electrically driven fan blower for a vehicle, the electric motor (2) being provided with a multipole connection (6), of which at least two connection elements (6a and 6b or 6b and 6c or 6a to 6c) are associated with a switching element (4) which is connected in parallel with the electric motor (2) such that it is in thermal contact with said electric motor (2) and such that, in the event of excessive temperatures, it causes the relevant switching element (4) to trip.

2. The arrangement as claimed in claim 1, in which the multipole connection (6) is in the form of a plug or cable connection.

3. The arrangement as claimed in claim 1, in which the switching element (4) is in the form of a normally closed contact (10), a normally open contact or a changeover switch (8).

4. The arrangement as claimed in claim 3, in which the switching element (4) in the form of a normally closed contact (10) or a normally open contact is connected between the positive or negative connection element (6a or 6c, respectively) and a further connection element (6b) of the multipole connection (6).

5. The arrangement as claimed in claim 3, in which the switching element (4) in the form of a changeover switch (8) is connected on the voltage side between the positive and the negative connection element (6a and 6c) of the multipole connection (6) and on the circuit side to a further connection element (6b).

6. The arrangement as claimed in claim 1, in which the multipole connection (6) is in the form of a three-pole connection or a two-pole connection having an additional contact.

7. The arrangement as claimed in claim 1, in which the switching element (4) is in the form of a temperature-dependent component.

8. The arrangement as claimed in claim 1, in which the switching element (4) is in the form of a thermal circuit breaker, in the form of a semiconductor component (11) or in the form of a temperature-dependent resistor (9).

9. The arrangement as claimed in claim 1, in which the switching element (4) is integrated in the electric motor (2).

10. The arrangement as claimed in claim 1, in which at least one interference suppression element (22) is connected in parallel with the switching element (4).

11. The arrangement as claimed in claim 1, in which the switching element (4) is designed such that tripping takes place at a temperature (Θ) of greater than 50° C.

12. The arrangement as claimed in claim 1, in which a fuse element (18) is provided for the purpose of disconnecting a circuit (H) supplying the electric motor (2) in the event of a critical limit value being exceeded.

13. The arrangement as claimed in claim 1, in which a feedback line (16) is connected to at least one connection element (6a or 6b) of a motor feed line.

14. The arrangement as claimed in claim 1, in which a feedback line (16) is connected to at least one connection element (6b) of a motor feed line via a decoupling element, in particular a diode (20).

15. The arrangement as claimed in claim 14, in which at least one decoupling element is arranged in the motor and/or in a drive circuit.

16. The arrangement as claimed in claim 1, in which at least one changeover element (U), in particular a relay (R1, R2) or an electronic switch, is provided for control as a function of the rotation speed.

17. The arrangement as claimed in claim 16, in which the changeover element (U) is connected to the feedback line (16).

18. The arrangement as claimed in claim 1, in which a switching element (4) is associated with each electric motor (2) in the case of two series-connected electric motors (2), said switching elements (4) tripping independently of one another.
